(19) United States
(12) Patent Application Publication
(10) Pub. No.: US 2017/0212880 A1
(43) Pub. Date: Jul. 27, 2017

(54) WEB-BASED APPLICATION RESPONSE ASSISTANCE

(71) Applicant: International Business Machines Corporation, Armonk, NY (US)

(72) Inventor: Henry P. Nash, Clevedon (GB)

(21) Appl. No.: 15/006,159

(22) Filed: Jan. 26, 2016

(51) Int. Cl. G06F 17/24; G06F 17/30; H04L 29/08

(52) U.S. Cl. CPC G06F 17/243; H04L 67/02; G06F 17/3053; G06F 17/30557

(57) ABSTRACT

In an approach for providing a response in a web based system, a computer receives a web based form. The computer identifies a user that is accessing the received web based form. The computer identifies an input field within the received web based form. The computer identifies a peer group associated with the identified user. The computer identifies one or more responses previously submitted to the received web based form within a database based on the identified peer group. The computer determines one or more responses within the identified one or more responses previously submitted that correspond to the identified input field. The computer ranks the determined one or more responses. The computer provides the ranked one or more responses to the identified user.

### BACKGROUND

The present invention relates generally to the field of web-based applications, and more particularly to providing responses for web-based applications based on previous responses provided by associates connected to a user via social networks.

Modern websites, through web-based applications, allow the capture, processing, storage, and transmission of user data for immediate and recurrent use. Web-based applications and services reside on a server, thus allowing users to submit and/or retrieve data to and/or from a database over the Internet from anywhere a connection to the Internet is able to be established. The data is presented to the user within the web browser as information generates dynamically in a specified format by the web-based application through the web server. A web-based application is any application that user a web browser as a client (e.g., message boards, webmail, login pages, support forms, product request forms, content management systems, social networking sites, etc.). A client-server environment is one in which multiple computers share information (e.g., entering information into a database). The client in the client-server environment, refers to the program a user utilizes to run the application and enter information. The server in the client-server environment, refers to the application used to store the information. While Web-based applications often run inside a Web-browser, Web based applications may also be client-based, where a portion of the program downloads to the computing device of a user, but the processing occurs over the Internet on an external server.

A social networking service is an online service, platform, or site that focuses on facilitating the building of social networks (i.e., web-based community of individuals) or social relations among people that share interests, activities, backgrounds, or real-life connections. A social network service consists of a representation of each user (often a profile), associated social links, and a variety of additional services. Most social network services are web-based and provide means for users to interact over the Internet, such as e-mail and instant messaging. Social networking sites allow users to share ideas, activities, events, and interests within their individual networks. Social networks range from friend-based networks (e.g., Facebook, MySpace, etc.) to business social networks (e.g., LinkedIn, XING, etc.) as well as internal business networks. General social networks do not focus on a particular topic or niche, but emphasize staying connected to friends and connecting to new people. Business social networks focus solely on interactions and relationships of a business nature rather than including personal, nonbusiness interactions. Users of a business social network maintain a list of business contacts and make new business connections for the purpose of professional networking (e.g., locate a new job, gain resources, etc.).

### SUMMARY

Aspects of the present invention disclose a method, computer program product, and system for providing a response in a web based system. The method includes one or more computer processors receiving a web based form. The method further includes one or more computer processors identifying a user that is accessing the received web based form. The method further includes one or more computer processors identifying an input field within the received web based form. The method further includes one or more computer processors identifying a peer group associated with the identified user. The method further includes one or more computer processors one or more responses previously submitted to the received web based form within a database based on the identified peer group. The method further includes one or more computer processors determining one or more responses within the identified one or more responses previously submitted that correspond to the identified input field. The method further includes one or more computer processors ranking the determined one or more responses. The method further includes one or more computer processors providing the ranked one or more responses to the identified user.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of a peer guidance program, on a server computer within the distributed data processing environment of FIG. 1, for providing instances of responses for web-based applications based on responses gathered through social networks to a peer guidance client program, in accordance with an embodiment of the present invention;

FIG. 3 is a block diagram of components of the server computer executing the peer guidance program, in accordance with an embodiment of the present invention.

### DETAILED DESCRIPTION

When utilizing the Web and web-based applications, as recognized by embodiments of the present invention, a user may be presented with questions that require an appropriate response and/or information to select from. Embodiments of the invention further recognize the user may not have previously encountered the question and/or information, and is therefore uncertain as to an appropriate response and/or a further course of action to take. Embodiments of the present invention collect data from peer groups associated with a user (e.g., social networks, professional work groups, industry experts, etc.) with respect to the presented questions and/or information (e.g., track responses of the peer group). Embodiments of the present invention analyze the responses of the peer group, and provide results of the analysis to the user, which the user may utilize to aid in entering an appropriate response and/or taking a further action.

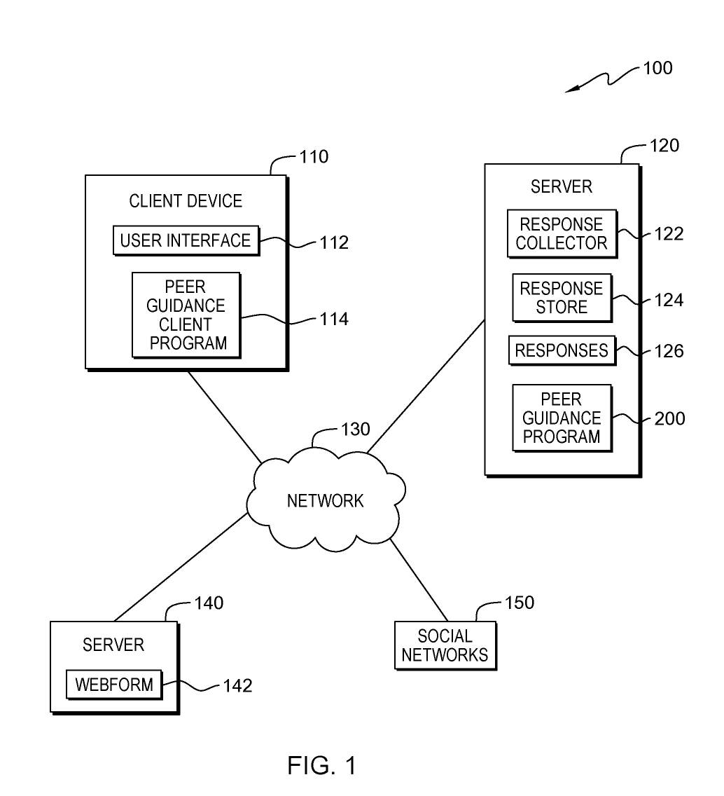

The present invention will now be described in detail with reference to the Figures. FIG. 1 is a functional block diagram illustrating a distributed data processing environment, generally designated 100, in accordance with one embodiment of the present invention. FIG. 1 provides only an illustration of one embodiment and does not imply any limitations with regard to the environments in which different embodiments may be implemented.

In the depicted embodiment, distributed data processing environment 100 includes client device 110, server 120, server 140, and social networks 150 interconnected over network 130. Distributed data processing environment 100 may include additional computing devices, mobile computing devices, servers, computers, storage devices, or other devices not shown.

Client device 110 may be an electronic device or computing system capable of processing program instructions and receiving and sending data. In some embodiments, client device 110 may be a laptop computer, a tablet computer, a netbook computer, a personal computer (PC), a desktop computer, a personal digital assistant (PDA), a smart phone, or any programmable electronic device capable of communicating with network 130. In other embodiments, client device 110 may represent a server computing system utilizing multiple computers as a server system, such as in a cloud computing environment. Client device 110 contains user interface 112 and peer guidance client program 114.

User interface 112 is a program that provides an interface between a user of client device 110 and a plurality of applications that reside on client device 110 (e.g., peer guidance client program 114) and/or may be accessed over network 130. A user interface, such as user interface 112, refers to the information (e.g., graphic, text, sound) that a program presents to a user and the control sequences the user employs to control the program. A variety of types of user interfaces exist. In one embodiment, user interface 112 is a graphical user interface. A graphical user interface (GUI) is a type of interface that allows users to interact with peripheral devices (i.e., external computer hardware that provides input and output for a computing device, such as a keyboard and mouse) through graphical icons and visual indicators as opposed to text-based interfaces, typed command labels, or text navigation. The actions in GUIs are often performed through direct manipulation of the graphical elements. User interface 112 sends and receives information through peer guidance client program 114 to peer guidance program 200.

Peer guidance client program 114 is a set of one or more programs designed to carry out the operations for a specific application to assist a user to perform an activity (e.g., provide responses 126 to response collector 122, connect to social networks 150, connect to webform 142, interact with peer guidance program 200, etc.). In the depicted embodiment, peer guidance client program 114 resides on client device 110. In another embodiment, peer guidance client program 114 may reside on a server or on another computing device (not shown) connected over network 130 provided peer guidance client program 114 is able to access peer guidance program 200. Peer guidance client program 114 sends information regarding webform 142 and social networks 150 that a user of client device 110 accesses and/or connects to. For example, peer guidance client program 114 indicates questions (e.g., input fields) with a survey form (e.g., webform 142) to peer guidance program 200 for analysis. Additionally peer guidance client program 114, identifies social networks 150 that the user of client device 110 connect to (e.g., peers, friends, industry experts, business associates, etc.) to peer guidance program 200 for further analysis with respect to webform 142.

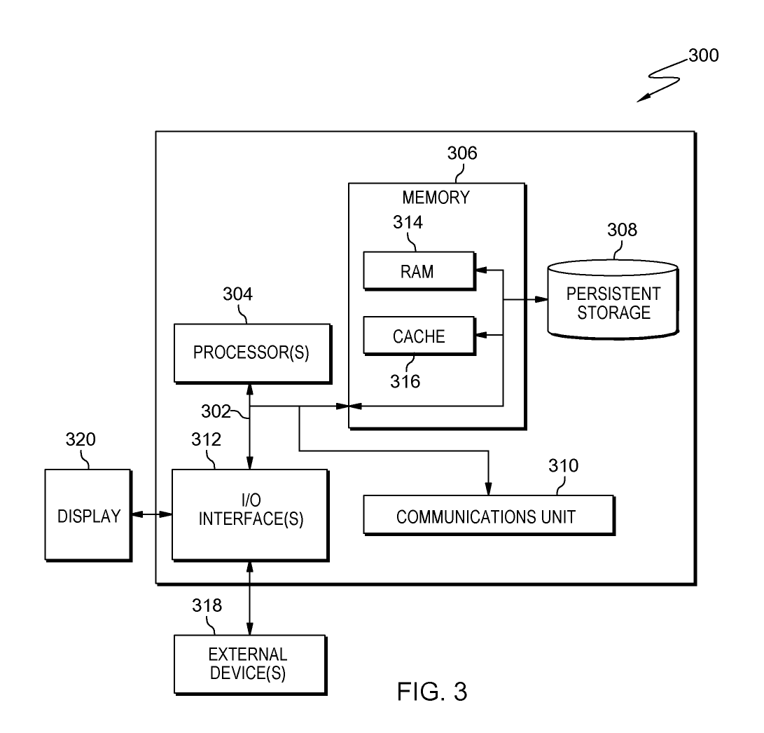

Servers 120 and 140 may be a management server, a web server, or any other electronic device or computing system capable of receiving and sending data. In some embodiments, servers 120 and 140 may be a laptop computer, a tablet computer, a netbook computer, a personal computer (PC), a desktop computer, a personal digital assistant (PDA), a smart phone, or any programmable device capable of communication with client device 110 and social networks 150 over network 130. In other embodiments, server 120 may represent a server computing system utilizing multiple computers as a server system, such as in a cloud computing environment. In general, server 120 is representative of any electronic device or combination of electronic devices capable of executing machine readable program instructions as described in greater detail with regard to FIG. 3, in accordance with embodiments of the present invention. Server 120 contains response collector 122, response store 124, responses 126, and peer guidance program 200 as depicted and described in further detail with respect to FIG. 3. Server 140 includes webform 142 as depicted and described in further detail with respect to FIG. 3.

Responses 126 refers to data entered and/or actions taken by a user as the user encounters queries and/or performs further actions when accessing webform 142, that response collector 122 gathers (e.g., monitors activates of the user of client device 110 through an augmented web browser) for further use. While in the depicted embodiment, only client device 110 is shown, additional client devices can be added which provide additional instances of responses 126 through response collector 122. As a user enters responses 126, response collector 122 collects the entered data and actions as responses 126. In one embodiment, the user selects to provide responses 126 anonymously (e.g., privacy setting). Response collector 122 gathers and stores responses 126 in response store 124 associated with the user, but restricts the identity of the user from being displayed in the future through peer guidance program 200 (i.e., the identify of user will not be provided to other users when associated with responses 126). In another embodiment, the user does not restrict other users from viewing the identity of the user when accessed in the future through peer guidance program 200 (e.g., attaches the identity of the user to responses 126). In some other embodiment, the user selects privacy settings to restrict the identity of the user from being displayed to some users, but allows the identity of the user to be provided to other users through peer guidance program 200. For example, the user may select to allow direct connections associated with the user within social networks 150 to view the identity of the user associated with responses 126, but does not allow connections that are associated with the direct connections but not directly connected to the user to view the identity of the user associated with responses 126 (e.g., connection is at least once removed from the user). In another example, the user may allow some direct connections (e.g., family) to view the identity of the user associated with responses 126 but does not allow other direct connections (e.g., business contacts) within the connections of social networks 150.

Additionally, response collector 122 tags responses 126 with information related to webform 142 (e.g., webpage, input field positioning, accessed hyperlink, input field criteria associated, etc.) and user information (e.g., user name, e-mail address, etc.) for the user accessing webform 142. Response collector 122 stores responses 126 with the accompanying data associated with the user and webform 142 in response store 124, which is a searchable repository (e.g., database). In one embodiment, in addition to storing responses 126, response store 124 stores peer groups (e.g., social networks 150) associated with individual users (e.g., the user of client device 110). In another embodiment, response store 124 stores links and credentials associated with individual users that access social networks 150. In the depicted embodiment, response collector 122, is a separate program operating within a web browser that collects responses 126 and stores responses 126 in response store 124. In another embodiment, response collector 122, response store 124, and responses 126 are incorporated within peer guidance program 200. In the depicted embodiment, responses 126, response collector 122, and response store 124 reside on server 120. In another embodiment, responses 126, response collector 122, and response store 124 may reside on a server or on another computing device (not shown) connected over network 130 provided response collector 122 has access to at least client device 110 (in order to gather responses 126), access to response store 124 (for storage of responses 126), and that response store 124 is accessible by peer guidance program 200.

Network 130 may be a local area network (LAN), a wide area network (WAN) such as the Internet, a wireless local area network (WLAN), any combination thereof, or any combination of connections and protocols that will support communications between client device 110, server 120, and other computing devices and servers (not shown), in accordance with embodiments of the inventions. Network 130 may include wired, wireless, or fiber optic connections.

In the depicted embodiment, webform 142 is a webpage accessed via a website that is hosted on at least one web server (e.g., server 140) that is accessible via network 130. In one embodiment, webform 142 is an Internet web based form which receives data entries into active webform fields via user interface 112. For example, a website presents the user with an instance of webform 142 that requests information pertaining to a job title, e-mail address, and company/business for the user to input within each individual field within webform 142. In another embodiment, webform 142 is a webpage in which selectable links (e.g., hyperlinks) are present that the user though user interface 112 can directly follow either by clicking or hovering. For example an instance of webform 142 displays hyperlinks associated with a search request that the user submits. In an alternate embodiment, webform 142 is an e-mail accessed through an e-mail client. In the depicted embodiment, webform 142 resides on server 140. In another embodiment, webform 142 may reside on a server or on another computing device (not shown) connected over network 130 provided webform 142 is accessible by client device 110 via user interface 112 (e.g., user initiated web browser on client device 110 through user interface 112, which connects to webform 142).

Social networks 150 consist of social networking services that are platforms to build social networks of social relations among individuals that share similar interests, activities, backgrounds, and/or real life connections (e.g., friend-based social networks, business social networks, etc.). Social network services consist of a representation of each user (e.g., profile), the social links associated with the user (e.g., create a list of users with whom to share connections, and view and cross the connections within the system), and additional services (e.g., career services). Social networks 150 include category places (e.g., employment, schooling, job title, profession, etc.), a means to connect with friends and/or colleagues, and a recommendation system linked to trust. Client device 110 connects to social networks 150 over network 130. Peer guidance program 200 accesses social networks 150 with respect to the user associated with client device 110 (e.g., obtains a peer group based on the social connections of the user of client device 110 and the instances of social networks 150 that the user connects to. For example, a user may be a member of more than one friend-based social network and/or business social network. In one embodiment, peer guidance program 200 is able to access each instance of social networks 150 that the user is a member of to obtain the peer group (e.g., social connections). In another embodiment, peer guidance program 200 is able to access instances of social networks 150, which the user is a member of, that the user identifies to obtain the peer group (i.e., user identifies which instances of social networks 150 can be utilized).

Peer guidance program 200 is a program for providing peer guided assistance in the form of responses 126 to a user accessing webform 142, that the user may view prior to selecting an action and/or entering a response. When a user access webform 142, peer guidance program 200 identifies users within social networks 150 that are associated with the user of client device 110 (e.g., friends, business connections, etc.). Peer guidance program 200 utilizes the identified users within social networks 150 and webform 142, to locate instances of responses 126 within response store 124 that match webform 142. Peer guidance program 200 performs an analysis of the instances of responses 126 and provides the results of the analysis of the instances of responses 126 to the user through peer guidance client program 114 for viewing. In the depicted embodiment, peer guidance program 200 resides on server 120. In another embodiment, peer guidance program 200 may reside on another server or on another computing device (not shown) connected over network 130 provided peer guidance program 200 has access to response store 124.

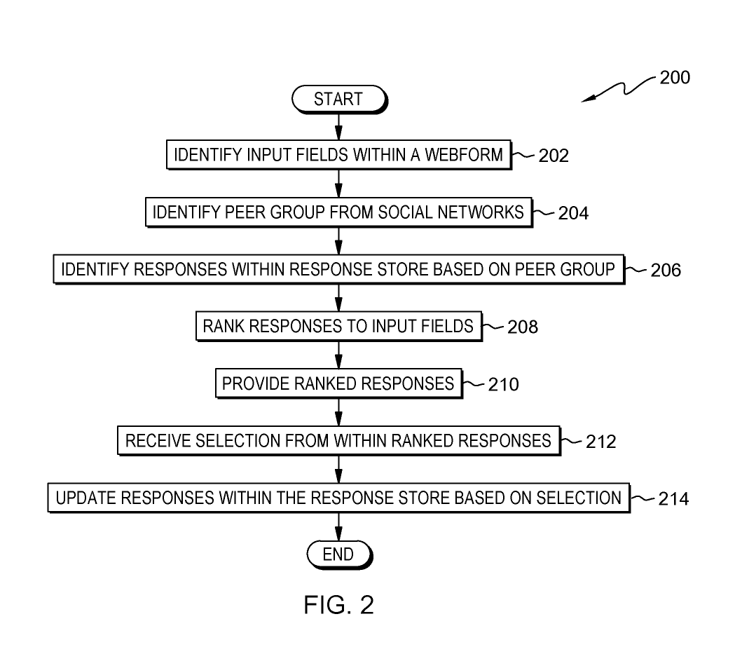

FIG. 2 is a flowchart depicting operational steps of peer guidance program 200, a program for providing instances of responses 126 for web-based applications based on responses 126 gathered through social networks 150 to a peer guidance client program 114, in accordance with an embodiment of the present invention. In an exemplary embodiment, peer guidance program 200 is incorporated within an augmented web browser (e.g., plugin). In another embodiment, peer guidance program 200 is a selectable option that the user may initiate from within the web browser. In another embodiment, peer guidance program 200 is included within an e-mail client. Response collector 122 is an ongoing data gathering process that adds responses 126 to response store 124 as users interact with instances of webform 142. Response collector 122 operates as part of the web browser, collecting responses 126 for further utilization by peer guidance program 200 and works in parallel with peer guidance program 200. For example, response collector 122 stores responses 126 (e.g., selections) made by users as responses 126 occur. Peer guidance program 200 initiates upon a user accessing webform 142 (e.g., connects to a website) through user interface 112.

In step 202, peer guidance program 200 identifies input fields within webform 142. Input fields refer to fields within webform 142 in which the user of client device 110 is able to enter data via user interface 112. Input fields can generate buttons, check boxes, drop down menus, and fields capable of receiving text and/or numerical responses, that the user interacts with in response to a prompt. For example, webform 142 is a customer service rating form that includes radio buttons for rating the customer service between one and five stars, and a comment section to add additional text to support the rating. In another embodiment, peer guidance program 200 identifies hyperlinks within webform 142. For example, webform 142 includes hyperlinks to create a new entry or work with an existing entry from which the user selects from. In some other embodiments, peer guidance program 200 identifies a combination of input fields and hyperlinks. Additionally, peer guidance program 200 identifies the uniform resource locator (URL) associated with webform 142 for utilization when accessing response store 124 in step 206. In an embodiment in which peer guidance program 200 includes response collector 122, peer guidance program 200 provides response collector 122 with the website associated with webform 142, which creates a new entry or accesses an existing entry, and stores data entered by the user of client device 110 within response store 124 with respect to webform 142.

In an alternate embodiment, peer guidance program 200 identifies webform 142 as an e-mail within an e-mail client. Peer guidance program 200 identifies information regarding relevant e-mail fields (e.g., sender, recipients, and subject) for further analysis. For example, the user receives an e-mail from UnknownUser@spam.com and a subject of “You are a winner!” Peer guidance program 200 stores the e-mail address and subject for further analysis. In some embodiments, peer guidance program 200 also stores the e-mail addresses of additional recipients when sent to more than one recipient for utilization in determining a peer group.

In step 204, peer guidance program 200 identifies peer groups from social networks 150. Peer guidance program 200 access social networks 150 that the user of client device 110 is a member of. Peer guidance program 200 accesses a contact list (e.g., connections, friends, department members, business links, etc.) within the individual instances of social networks 150 associated with the user. In another embodiment, peer guidance program 200 retrieves the address book from the e-mail client of the user as the peer group. In some other embodiment, peer guidance program retrieves contacts within an internal messaging program as the peer group. Peer guidance program 200 retrieves the contact information associated with the connections identified within the contact list through social networks 150 and/or the e-mail clients (e.g., name, relationship to the user, place of employment, job title, e-mail address, etc.). Peer guidance program 200 creates the peer group based on the contact information for the user of client device 110. In some embodiment, peer guidance program 200 also stores the created peer group with respect to the user of client device 110 within response store 124 for further use in subsequent iterations of peer guidance program 200 (e.g., reuses a peer group, only adds new members to an existing peer group, removed deleted connections form peer group, etc.).

For example, the user of client device 110 is a member of multiple instances of social networks 150, a friend based social network, a business social network, and a peer-to-peer computer network (e.g., department workgroup). Peer guidance program 200 collects the contact information associated with friends from the friend based social network, the business colleagues from the business social network, and work colleagues form the peer-to-peer computer network. Peer guidance program 200 combines the contact information from the three instances of social networks 150 into one composite peer group, that includes the contact information and which instance of social networks 150 the contact and associated contact information was collected from.

In step 206, peer guidance program 200 identifies instances of responses 126 within response store 124 based on the peer groups. Peer guidance program 200 searches response store 124 based on the contact information for the members of the peer group (e.g., user name, e-mail address, first and last name, etc.). Additionally, upon locating a match, peer guidance program 200 searches for instances of webform 142 within the stored data associated with the matching member of the peer group within response store 124. In one embodiment, peer guidance program 200 retrieves instances of responses 126 associated with an individual input field. In another embodiment, peer guidance program 200 retrieves instances of responses 126 associated with the entirety of input fields and/or hyperlinks within webform 142. Peer guidance program 200 stores the matching instances of responses 126 for further evaluation. Peer guidance program 200 searches response store 124 for each of the identified members of the peer group and adds additional matching instances of responses 126 to previously collected matching instances of responses 126. In some embodiments, peer guidance program 200 may not identify members of the peer group and/or webform 142 within response store 124, and peer guidance program 200 does not store instances of responses 126 for further evaluation (e.g., null set).

For example, the user of client device 110 through peer guidance client program 114 accesses webform 142 to purchase tickets to an ice hockey game. Webform 142 includes a hyperlink to a seating chart, and input fields for a game date, number of tickets to purchase, and how to select tickets: pricing, best seat available, and self-selection. Peer guidance program 200 records the website associated with webform 142, and identifies the seating chart hyperlink and the three input fields (step 202). Peer guidance client program 114 accesses social networks 150 and identifies a peer group of five connections: John, Joe, Jack, Jill, and Julie (step 204). Peer guidance program 200 accesses response store 124 and searches for instances of responses 126 associated with John, Joe, Jack, Jill and Julie (e.g., locates data stored associated with individual users within response store 124). Peer guidance program 200 also searches within the instances of responses 126 associated with John, Joe, Jack, Jill, and Julie for webform 142. Peer guidance program 200 identifies instances of responses 126 associated with John, Jack, and Jill that correspond to webform 142, but does not identify matches within response store 124 for Joe and Julie associated with webform 142. Peer guidance program 200 retrieves and stores the instances of responses 126 associated with John, Jack, and Jill associated with the hyperlinks and three input fields for further analysis.

In step 208, peer guidance program 200 ranks instances of responses 126 to the input fields within webform 142. Peer guidance program 200 applies data analytics to the instances of responses 126. In one embodiment, peer guidance program 200 ranks instances of responses 126 based on a frequency of selection of data and/or actions taking with respect to instances of responses 126 (e.g., percentage of each response out of total). For example, the user receives an e-mail at work. Peer guidance program 200 identifies fifty members of the peer group that received an identical e-mail based on subject and sender within response store 124. Peer guidance program 200 retrieves the instances of responses 126 from response store 124, and determines of the fifty instances of responses 126, thirty-five instances of responses 126 (70%), marked the e-mail as spam, ten instances of responses 126 (20%), deleted the e-mail without opening, and five instances of responses 126 (10%), opened the e-mail. Peer guidance program 200 ranks the instances of responses 126 from highest to lowest, showing the most likely response of 70%, which marks the e-mail as spam, first.

In another embodiment, peer guidance program 200 applies weights to the instances of responses 126 based on expertise. In one embodiment, peer guidance program 200 applies text analytics to determine expertise. For example, a user selects to create a legal document online. Within the peer group, peer guidance program 200 applies text analytics to identify members within the peer group that include job titles, educations, degrees, and employers associated with the legal profession (e.g., lawyers, paralegals, law degree, law firms, etc.). Peer guidance program 200 assigns a higher weight value to the corresponding instances of responses 126 associated (e.g., correlate) with the legal profession than instances of responses 126 associated with members of the peer group not in the legal profession. Peer guidance program therefore ranks the instances of responses 126 from the legal profession higher. In another embodiment, peer guidance program 200 receives user selections though peer guidance client program 114, that identify expertise. For example, a friend of the user is a lawyer, but the friend does not include a job title, place of employment, and/or degree within an associated social profile within social networks 150. The user therefore identifies the friend as an expert, and peer guidance program 200 weights instances of responses 126 associated with the friend higher.

In some other embodiment, peer guidance program 200 applies weights to the instances of responses 126 based on a trust level percentage (e.g., level of confidence, statistical measurability of a reliability of a result). In one embodiment, the user through peer guidance program 200 assigns members within the peer group with trust level percentages that may be fixed and/or selected case by case. For example, the peer group includes friends, family members, and business associates. The user works as a stock broker and accesses stock investment plans, while at work and accessing the stock investment plans, the user applies the highest trust level percentage to business associates and lower trust levels to family members and friends. However, when accessing non-business related instances of webform 142 such as applications within an application store for programs to install on a mobile computing device, the same user applies higher trust level percentages to family and friends than business associates.

In yet another embodiment, peer guidance program 200 determines the trust level percentage based on a frequency of occurrence. The frequency of occurrence identifies the number of times the user selects a response within responses 126 from the individual members of the peer group. Peer guidance program 200 records and tracks the number of times the user makes a selection that corresponds with an instance of responses 126 associated with peer group members. Peer guidance program 200 assigns a higher trust percentage to peer group members that the user selects instances of responses 126 more frequently (e.g., values responses higher) than responses from peer group members that the user selects less often. For example, the user through peer guidance program 200 selects instances of responses 126 associated with Jack ninety percent of the time and instances of responses 126 associated with Jill ten percent of the time. Therefore, peer guidance program 200 assigns a higher trust level percentage to Jack than Jill, and weights instance of responses 126 associate with Jack higher that instances of responses 126 associated with Jill.

In yet some other embodiments, peer guidance program 200 ranks responses 126 based upon accuracy of responses associated with a connection within social networks 150 and/or a trust level. Peer guidance program 200 utilizes data analytics to track which instances of responses 126 associated with the users (e.g., connections) within social networks 150 provide the most accurate responses 126 for a topic to the user requesting assistance. For example, Jack is a friend, Jill is a teacher, and Joe works in finance. From the previous example, peer guidance program 200 determines the user selects information from Jack ninety percent of the time and from Jill ten percent of the time, but does not select from Joe. However, peer guidance program 200 determines the accuracy across social networks 150 with respect to finance to be: fifty percent for Jill, forty percent for Jack, and ninety percent for Joe. Peer guidance program 200 ranks responses 126 based on both the trust level percentage and the accuracy. Therefore, peer guidance program 200 ranks Jack first, Joe second, and Jill third. However, for another user that shares similar connections that does not include a trust level, but tracks accuracy, peer guidance program 200 ranks responses 126 associated with Jack, Joe, and Jill to be Joe first (90%), Jill second (50%), and Jack third (40%).

In some other embodiments, peer guidance program 200 utilizes an expert panel to provide and rank instances of responses 126. In one embodiment, peer guidance program 200 provides the user with an option through peer guidance client program 114 to access the expert panel (i.e., established professional peer group with instances of responses 126) to provide ranked instances of responses 126. For example, a user is accessing a medical website, but peer guidance program 200 does not identify users within social networks 150 associated with the user and the medical website to form a peer group and/or the user prefers to receive instances of responses 126 associated with only medical professionals. The user through peer guidance client program 114 selects to utilize the expert panel, and peer guidance program 200 retrieves the instances of responses 126 associated with the expert panel for webform 142 and provides a ranking. In another embodiment, peer guidance program 200 incorporates the expert panel in addition to instances of responses 126 associated with the peer group. Peer guidance program 200 applies a higher weight to the instances of responses 126 associated with the expert panel than the instances of responses 126 associated with the members of the peer group identified through social networks 150.

In yet some other embodiments, peer guidance program 200 utilizes multiple weights associated with frequency of selection, trust level, expertise, and/or panel of experts to determine the ranking of instances of responses 126. Peer guidance program 200 calculates a weighted value associated with the individual types of data present and/or collected associated within the instances of responses 126 and calculates an overall weighted value. For example, peer guidance program 200 identifies a member of the peer group through text analytics as an expert and a high trust level. Therefore, peer guidance program 200 applies the corresponding weight provided by an expert and the high trust level to instances of responses 126 (e.g., results in a higher weighted value through the combination of the two weights). Peer guidance program 200 orders the instances of responses 126 based on the combined weighted values.

In step 210, peer guidance program 200 provides the ranked instances of responses 126. In one embodiment, peer guidance program 200 provides the user information associated with the ranked instances of responses 126 when available (i.e., based on privacy settings of the users providing responses 126). In another embodiment, peer guidance program 200 provides ranked instances of responses 126 without user information (e.g., privacy settings do not allow user information to be provided, user selects to not view identity information of the users associated with responses 126). In one embodiment, peer guidance program 200 provides ranked instances of responses 126 when the user hovers over an input field and or text box. For example, prior to installing software on client device 110, the user must accept the terms and conditions. The user moves the mouse to hover over the accept box, and peer guidance program 200 provides a summary of the results of the instances of responses 126 for the user to view, 95% accept, 5% decline and exit.

In another embodiment, peer guidance program 200 provides ranked instances of responses 126 in response to selection of a programed hot key and/or key selection sequence. In some other embodiment, peer guidance program 200 provides ranked instances of responses 126 through color coding. For example within an e-mail client, peer guidance program 200 marks e-mails suspected of being spam in red, suspicions e-mails as yellow, and safe e-mails as green. In some other embodiments, peer guidance program 200 provides the ranked instances of responses 126 within a drop down menu. For example, a user is building a custom computing device that includes six options for graphics cards. Peer guidance program 200 appends the drop down menu of the six graphics card options with the associated ranking for future selection through the plugin to the web browser.

In step 212, peer guidance program 200 receives a selection from within the ranked instances of responses 126. In one embodiment, the user through peer guidance client program 114 selects a ranked instance of responses 126. For example, the user selects to follow the hyperlink within webform 142 associated with viewing the seating chart prior to selecting seats. In another embodiment, the user through peer guidance client program 114 enters a response not within the ranked instances of responses 126. For example, webform 142 includes a text field with customer improvement suggestions. Peer guidance program 200 provides the user with previously entered customer improvement suggestions, but the user declines to select a previous customer improvement suggestion, and enters an alternate improvement suggestion.

In one embodiment, peer guidance program 200 records the selection made by the user from the ranked instances of responses 126 and identifies corresponding member information. For example, the peer group includes John, Joe Jack, Jill and Julie. The user selects instance of responses 126 associated with Julie which peer guidance program 200 records. In another embodiment peer guidance program 200 records a new entry (e.g., no instances of responses 126 were found in response store 124 and/or the user enters a new instance of responses 126. For example, the user enters a new instance of responses 126 and peer guidance program 200 records the new instance of responses 126 and the creator of the instance of responses 126.

In step 214, peer guidance program 200, updates the instances of responses 126 within response store 124 based on the selection. For example, peer guidance program 200 accesses the number of times the user selects instances of responses 126 from Julie, and increments the overall count which may change the trust level percentage associated with Julie in further iterations of peer guidance program 200. Additionally peer guidance program 200 updates the overall number of times an instance of responses 126 is selected by a user. In an embodiment in which the user enters a new instance of responses 126, peer guidance program 200 provides the new instance of responses 126 to response collector 122 for incorporation into response store 124. Additional iterations of peer guidance program 200 utilize the updates to response store 124.

FIG. 3 depicts a block diagram of components of computer 300 in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Computer 300 includes communications fabric 302, which provides communications between cache 316, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses or a crossbar switch.

Memory 306 and persistent storage 308 are computer readable storage media. In this embodiment, memory 306 includes random access memory (RAM) 314. In general, memory 306 can include any suitable volatile or non-volatile computer readable storage media. Cache 316 is a fast memory that enhances the performance of computer processor(s) 304 by holding recently accessed data, and data near accessed data, from memory 306.

User interface 112, peer guidance client program 114, response collector 122, response store 124, responses 126, peer guidance program 200, webform 142, and social networks 150 may be stored in persistent storage 308 and in memory 306 for execution and/or by one or more of the respective computer processor(s) 304 via cache 316. In an embodiment, persistent storage 308 includes a magnetic hard disk drive. Alternatively, or in addition to a magnetic hard disk drive, persistent storage 308 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices. In these examples, communications unit 310 includes one or more network interface cards. Communications unit 310 may provide communications through the use of either or both physical and wireless communications links. User interface 112, peer guidance client program 114, response collector 122, response store 124, responses 126, peer guidance program 200, webform 142, and social networks 150 may be downloaded to persistent storage 308 through communications unit 310.

I/O interface(s) 312 allows for input and output of data with other devices that may be connected to computer 300. For example, I/O interface(s) 312 may provide a connection to external device(s) 318, such as a keyboard, a keypad, a touch screen, and/or some other suitable input device. External devices 318 can also include portable computer readable storage media such as, for example, thumb drives, portable optical or magnetic disks, and memory cards. Software and data used to practice embodiments of the present invention, e.g., user interface 112, peer guidance client program 114, response collector 122, response store 124, responses 126, peer guidance program 200, webform 142, and social networks 150, can be stored on such portable computer readable storage media and can be loaded onto persistent storage 308 via I/O interface(s) 312. I/O interface(s) 312 also connect to a display 320.

Display 320 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for providing a response in a web based system the method comprising:
receiving, by one or more computer processors, a web based form;
identifying, by one or more computer processors, a user that is accessing the received web based form;
identifying, by one or more computer processors, an input field within the received web based form;
identifying, by one or more computer processors, a peer group associated with the identified user;
identifying, by one or more computer processors, one or more responses previously submitted to the received web based form within a database based on the identified peer group;
determining, by one or more computer processors, one or more responses within the identified one or more responses previously submitted that correspond to the identified input field;
ranking, by one or more computer processors, the determined one or more responses; and
providing, by one or more computer processors, the ranked one or more responses to the identified user.

2. The method of claim 1, wherein identifying the peer group associated with the identified user further comprises:
identifying by one of more computer processors, one or more social networks associated with the identified user;
retrieving, by one or more computer processors, social connections from the one or more social networks; and
creating, by one or more computer processors, the peer group based on the retrieved social connections.

3. The method of claim 1, wherein ranking the determined one of more responses further comprises:
determining, by one or more computer processors, a frequency of occurrence within the determined one or more responses; and
ranking, by one or more computer processors, the determined one or more responses base on the determined frequency of occurrence.

4. The method of claim 1, wherein ranking the determined one of more responses further comprises:
determining, by one or more computer processors, a trust level associated with a member of the peer group, wherein the trust level is a statistical measurability of a reliability of a result that includes one or more of: assigned trust levels and calculated trust levels;
applying, by one or more computer processors, a weighting to the determined one or more responses based on the determined trust level; and
ranking, by one or more computer processor, the weighted one on more responses.

5. The method of claim 1, wherein ranking the determined one of more responses further comprises:
applying, by one or more computer processors, text analytics to the received input field;
applying, by one or more computer processors, text analytics to the identified peer group;
identifying, by one or more computer processors, members of the identified peer group that correlate with the received input field based on the applied text analytics;
applying, by one or more computer processors, a weighting to the determined one of more responses associated with the identified members of the identified peer group that correlate with the received input field based on the applied text analytics; and
ranking, by one or more computer processor, the weighted one on more responses.

6. The method of claim 1, wherein ranking the determined one of more responses further comprises:
receiving, by one or more computer processors, a selection of an expert panel;
retrieving, by one or more computer processors, from the database one or more responses associated with the received expert panel;
applying by one or more computer processors, a weighting to the retrieved one or more responses associated with the received expert panel; and
ranking, by one or more computer processor, the weighted one on more responses.

7. The method of claim 1, further comprises:
receiving, by one or more computer processors, a selection from the provided ranked one or more responses; and
updating, by one or more computer processors, the database based on the received selection.

8. A computer program product for providing a response in a web based system the computer program product comprising:
one or more computer readable storage media and program instructions stored on the one or more computer readable storage media, the program instructions comprising:
program instructions to a web based form;
program instructions to identify a user that is accessing the received web based form;
program instructions to identify an input field within the received web based form;
program instructions to identify a peer group associated with the identified user;
program instructions to identify one or more responses previously submitted to the received web based form within a database based on the identified peer group;
program instructions to determine one or more responses within the identified one or more responses previously submitted that correspond to the identified input field;
program instructions to rank the determined one or more responses; and
program instructions to provide the ranked one or more responses to the identified user.

9. The computer program product of claim 8, wherein to identify the peer group associated with the identified user further comprises one or more of the following program instructions, stored on the one or more computer readable storage media, to:
identify one or more social networks associated with the identified user;
retrieve social connections from the one or more social networks; and
create the peer group based on the retrieved social connections.

10. The computer program product of claim 8, wherein ranking the determined one of more responses further comprises one or more of the following program instructions, stored on the one or more computer readable storage media, to:
determine a frequency of occurrence within the determined one or more responses; and
rank the determined one or more responses base on the determined frequency of occurrence.

11. The computer program product of claim 8, wherein to rank the determined one of more responses further comprises one or more of the following program instructions, stored on the one or more computer readable storage media, to:
determine a trust level associated with a member of the peer group, wherein the trust level is a statistical measurability of a reliability of a result that includes one or more of:
assigned trust levels and calculated trust levels;
apply a weighting to the determined one or more responses based on the determined trust level; and
rank the weighted one on more responses.

12. The computer program product of claim 8, wherein to rank the determined one of more responses further comprises one or more of the following program instructions, stored on the one or more computer readable storage media, to:
apply text analytics to the received input field;
apply text analytics to the identified peer group;
identify members of the identified peer group that correlate with the received input field based on the applied text analytics;
apply a weighting to the determined one of more responses associated with the identified members of the identified peer group that correlate with the received input field based on the applied text analytics; and
rank the weighted one on more responses.

13. The computer program product of claim 8, wherein to rank the determined one of more responses further comprises one or more of the following program instructions, stored on the one or more computer readable storage media, to:
receive a selection of an expert panel;
retrieve from the database one or more responses associated with the received expert panel;
apply a weighting to the retrieved one or more responses associated with the received expert panel; and
rank the weighted one on more responses.

14. The computer program product of claim 8, further comprises one or more of the following program instructions, stored on the one or more computer readable storage media, to:
receive a selection from the provided ranked one or more responses; and
update the database based on the received selection.

15. A computer system for providing a response in a web based system the computer system comprising:
one or more computer processors, one or more computer readable storage media, and program instructions stored on the computer readable storage media for execution by at least one of the one or more processors, the program instructions comprising:
program instructions to a web based form;
program instructions to identify a user that is accessing the received web based form;
program instructions to identify an input field within the received web based form;
program instructions to identify a peer group associated with the identified user;
program instructions to identify one or more responses previously submitted to the received web based form within a database based on the identified peer group;
program instructions to determine one or more responses within the identified one or more responses previously submitted that correspond to the identified input field;
program instructions to rank the determined one or more responses; and
program instructions to provide the ranked one or more responses to the identified user.

16. The computer system of claim 15, wherein to identify the peer group associated with the identified user further comprises one or more of the following program instructions, stored on the one or more computer readable storage media, to:
identify one or more social networks associated with the identified user;
retrieve social connections from the one or more social networks; and
create the peer group based on the retrieved social connections.

17. The computer system of claim 15, wherein ranking the determined one of more responses further comprises one or more of the following program instructions, stored on the one or more computer readable storage media, to:
determine a frequency of occurrence within the determined one or more responses; and
rank the determined one or more responses base on the determined frequency of occurrence.

18. The computer system of claim 15, wherein to rank the determined one of more responses further comprises one or more of the following program instructions, stored on the one or more computer readable storage media, to:
determine a trust level associated with a member of the peer group, wherein the trust level is a statistical measurability of a reliability of a result that includes one or more of:
assigned trust levels and calculated trust levels;
apply a weighting to the determined one or more responses based on the determined trust level; and
rank the weighted one on more responses.

19. The computer system of claim 15, wherein to rank the determined one of more responses further comprises one or more of the following program instructions, stored on the one or more computer readable storage media, to:
apply text analytics to the received input field;
apply text analytics to the identified peer group;
identify members of the identified peer group that correlate with the received input field based on the applied text analytics;
apply a weighting to the determined one of more responses associated with the identified members of the identified peer group that correlate with the received input field based on the applied text analytics; and
rank the weighted one on more responses.

20. The computer system of claim 15, wherein to rank the determined one of more responses further comprises one or more of the following program instructions, stored on the one or more computer readable storage media, to:
receive a selection of an expert panel;
retrieve from the database one or more responses associated with the received expert panel;
apply a weighting to the retrieved one or more responses associated with the received expert panel; and
rank the weighted one on more responses.
